(19) United States
(12) Patent Application Publication
(10) Pub. No.: US 2007/0101645 A1
(43) Pub. Date: May 10, 2007

(54) Automatically watered and illuminated plant stand

(76) Inventors: Chase P. Christopher, San Juan Capistrano, CA (US); William L. Downing, San Juan Capistrano, CA (US)

Correspondence Address: PATENT LAW & VENTURE GROUP, 2424 S.E. BRISTOL, SUITE 300, NEWPORT BEACH, CA, 92660, US

(21) Appl. No.: 11/268,175

(22) Filed: Nov. 7, 2005

(51) Int. Cl. A47G 7/02; A01G 27/00

(52) U.S. Cl. 47/67; 47/79

(57) ABSTRACT

A plant watering and illuminating apparatus has a central tube having at one end an adaptor for supporting the central tube in a vertical attitude. The other end of the central tube terminates with tubular arms extending laterally away from the central tube, each with an arc shape. The tubular arms terminate with plant hangers supporting plant pots depending downwardly. A water conduit conducts water through the central tube and the tubular arms to sprinkler heads within the plant pots. A source of illumination is engaged with the tubular arms and an electrical conduit conducts electricity from an electrical source through the central tube and the tubular arms, to the illumination source.

### BACKGROUND OF THE INVENTION

1. Field of the Present Disclosure

This disclosure relates generally to plant watering devices and more particularly to a plant stand with plant watering and illuminating capability.

2. Description of Related Art Including Information Disclosed Under 37 CFR 1.97 and 1.98

Hardison, U.S. D392853, discloses a design patent for support of lawn and garden ornaments. Humphrey, U.S. D480229, discloses a design for a single-arm stand. Cooper, U.S. 2002/0189163, discloses a self-watering plant holder that has a central, upright post with four horizontal radial arms extending outwardly thereof. A plant container, such as a bucket with a handle, is mounted on each radial arm. A base extends radially outwardly in a preferred embodiment from the lower end of the post to support the post. A manifold is mounted to the post, and houses a chamber with a closure for the addition of water and/or fertilizer. Watering lines extend from the manifold into one or more of the plant containers for watering and/or feeding the plants. Whitehead, U.S. Pat. No. 2,744,786, discloses a lawn sprinkler that has a casing with internal vertical guides extending throughout the length of the casing. There is a weighted piston loosely mounted inside with a central aperture. There is a water-metering device located in the piston for regulating the amount of water flowing through the piston. The previously mentioned vertical guides prevent the turning of the piston within the casing. A flexible rubber tube is secured to the upper end of the piston and is provided with spiral grooves on its outer circumference and substantially throughout its length. The flexible tube is sealed at its outer end and provided with an opening slightly below the sealed upper end to form a resultant pocket whose opening extends at substantially right angles to the central axis of the tube and in a direction away from the central casing so the water will be thrown or sprayed away from the sprinkler. There is a valve closure near the upper end of the piston, an inlet pipe extending within the bottom of the casing, and a top for the casing that provides a central orifice of slightly greater internal diameter than the outside diameter of the tube. The bottom of the cap acts as a valve seat, the valve closure being less in outside diameter than the inside diameter of the casing. The piston and rubber tube are adapted to rise in the casing when water is admitted through the casing and to flow around the valve closure and through the aperture in the cap until the piston reaches its full height. The value closure will then press against the aforementioned valve seat to prevent the water from going out through he opening in the cap around the tube to cause the water to flow only through the rubber tube. Due to the spiral grooves about the tube, the resultant pocket in the closed off end of the tube and the opening slightly below the pocket will cause the tube to bend at substantially right angles where it projects through the cap and extend in a horizontal direction for the greater part of its length. It will than assume a nearly vertical position and the size of the arc in which the tube will swing is dependent upon he amount of flow of water through the metering device. Whitehead, U.S. Pat. No. 2,752,195, discloses a lawn sprinkler casing with a weighted piston loosely mounted within that has a central aperture, a flexible rubber tube secured to the upper end of the piston, and spiral grooves on its outer circumference throughout the length. There is a value closure that is secured near the upper end of the piston, and inlet pipe that extends within the bottom of the casing, a cap for the top of the casing, which is provided, with a central orifice of slightly greater internal diameter than the outside diameter of the tube. The bottom of the cap acts a value seat. The value closure has a smaller diameter than the internal diameter of the casing. The piston and the rubber tube are adapted to rise in the casing when water is admitted to the casing and to flow around the valve closure and through the aperture in the cap until the piston reaches it full height. This will cause the value closure to close the value and prevent the water from going out through the opening in the cap around the tube to then cause the water to flow only through the rubber tube and, due to the spiral grooves about the tube, will cause the tube to swing in a circle with the top of the cap as a pivotal point. Albano, U.S. Pat. No. 2,954,932, discloses a sprinkler that comprises an airborne support which has downwardly directed jets that are inclined to levitate and propel the support in an airborne relation. It has flexible tubing that extends to the jets on the airborne support and a means for supplying sustentation and propulsion fluid through the flexible tubing to the jets and includes water supply connections that terminate in a ground supported swivel. The flexible tubing is connected with the swivel to thereby supply water for sustaining and propelling the support in a circular area about the ground swivel with the downwardly directed jets sprinkling the circulated area about the swivel. Araujo, U.S. Pat. No. 3,325,102, discloses a fluid disperser that has a hollow main body portion that includes an inlet and an outlet. The outlet is connected to a flexible tube at one end and the flexible tube has a fluid dispersing outlet at the other end. A sheet of bendable material that has a plurality of openings is mounted on the flexible tube by means of the openings in frictional engagement. A swivel bearing is mounted on the flexible tube near the dispersing outlet and a length of flexible material is conned to the swivel bearing and adapted to rotate with relation thereto. There is a sheet of bendable material that has a plurality of openings mounted on the length of flexible material by means of the openings in frictional engagement and a stop means at an end of the length of flexible material to prevent disengagement of the second mentioned sheet of material. Sawers, U.S. Pat. No. 3,488,001, discloses a watering device that has a spray head and a flexible tube which is non-rotatably secured at one end to the spray head and has a nozzle at the other end. A rigid restraining member in the tube extends from the nozzle into the spray head and is shaped to locate the nozzle offset from the axis of the fixed end of the tube. The restraining member is supported for rotation about an axis which is substantially coaxial with the fixed end of the discharge tube. Baker, U.S. Pat. No. 3,633,826, discloses a lawn sprinkler comprised of only an elongated, tubular body threaded on at least one end for connection to a hose, a ground engaging support means on the body, and a flexible discharge tube removably attached to an outlet fitting on the top of the tubular body. The flow of pressurized water through the discharge tube, preferable an 8 to 10 inch length of rubber tubing, causes the flexible discharge tube to rapidly rotate through an arcuate path to thereby distribute water in an even pattern. Uzrad, U.S. Pat. No. 4,684,066, discloses a flexible tube sprinkler that has a connector at one end, a nozzle at the opposite end, and a flexible tube between the connector and nozzle permitting free movement of the nozzle by the weight thereof and by the reaction forces of the water discharged therefrom. Enclosing the connector end of the flexible tube is a rigid sleeve that has an axial bore of larger diameter than the external diameter of the connector end of the flexible tube such that there is a clearance between the inner face of the rigid sleeve and the outer face of the connector end of the flexible tube permitting the rigid sleeve to be impacted by the flexible tube during the operation of the sprinkler to control the movements of the flexible tube and thereby the distribution of the water discharged from the nozzle. Wesolowski, U.S. Pat. No. 5,806,239, discloses an apparatus for watering a plant while it is supported in an elevated position which includes an elongated tubular standard which has a longitudinal axial passageway and upper and lower end portions and which is mounted in an upstanding position. A flexible hose is threaded through the passageway of the standard and has upper and lower end portions respectively projecting from the upper and lower end portions of the standard. A hanger is provided on the upper end portion of the standard for supporting a plant, and a nozzle is attached to the upper end portion of the hose in a position to dispense water to the plant either by a drip irrigation method or by a spay or other method. The lower end portion of the hose is connected to a source of water under pressure for supplying water to the nozzle. The apparatus provides an attractive support for a plant while enabling it to be regularly watered. It can be manufactured from a plurality of parts which in disassembled condition are convenient for distribution and sale and final assembly by a user. Also, the apparatus supports the plant in such a manner that water dripping from its container does not contact the apparatus and cause corrosion and wear. Wesolowski, U.S. Pat. No. 5,974,731, discloses an apparatus for watering a plant while it is supported in an elevated position which includes an elongated tubular standard which has a longitudinal axial passageway and upper and lower end portions and which is mounted in an upstanding position. A flexible hose is threaded through the passageway of the standard and has upper and lower end portions respectively projecting from the upper and lower end portions of the standard. A hanger is provided on the upper end portion of the standard for supporting a plant, and a nozzle is attached to the upper end portion of the hose in a position to dispense water to the plant either by a drip irrigation method or by a spay or other method. The lower end portion of the hose is connected to a source of water under pressure for supplying water to the nozzle. The apparatus provides an attractive support for a plant while enabling it to be regularly watered. It can be manufactured from a plurality of parts which in disassembled condition are convenient for distribution and sale and final assembly by a user. Also, the apparatus supports the plant in such a manner that water dripping from its container does not contact the apparatus and cause corrosion and wear. Ito, U.S. Pat. No. 6,269,588, discloses a flower pot for group planting of flower plants or the like which is mounted on a pole that comprises a flower pot body having planting openings of which the upper part is opened and provided in a plurality of locations in the periphery of said body, and having a hole provided in the bottom of the body for inserting the pole; and a cylindrical mounting member for inserting the upper part of the pole, at least the bottom of said mounting member is opened and said mounting member is fixedly or removably mounted vertically around said hole. The outer face of said flower pot is covered by the group planted flower plants and not exposed when said flower pot in which flower plants have been group planted is mounted on the pole, and accordingly the beauty of the flowers planted in said flower pot is kept well and the decoration effect is increased, and said flower pot is securely mounted on the pole and accordingly does not fall even when subjected to strong winds. Holley, U.S. Pat. No. 6,843,022, discloses an apparatus that includes a central support conduit having a hollow fluid passageway. A plurality of downwardly arching arms extend radially outward from the central support conduit for carrying a plant container. A mounting sleeve is carried on the central support conduit that includes a plurality of arm brackets for carrying the arms. A fluid distribution hub is carried by the central support conduit and has a chamber in fluid communication with the hollow fluid passageway, and a plurality of fluid diversion conduits extending radially outward from the chamber. A plurality of watering lines, each carrying a valve to control fluid flow through the lines, extend radially outward from the fluid distribution hub. Each watering line has a source end in fluid communication with one of the fluid diversion conduits, and a nozzle end disposed near a distal end of one of the arms for channeling fluid into the plant container.

The related art described above discloses hollow plant stands, aerial based lawn sprinklers, decorative fluid dispensers, sprinklers with flexible tube heads, fluid supply to self watering plant stands, and various ornamental plant hanger designs. However, the prior art fails to disclose decorative plant stands that are self watering and self illuminating, and which contain within their rigid structure, the means for self-watering and illumination.. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

A plant watering and illuminating apparatus has a central tube having at one end an adaptor for supporting the central tube in a vertical attitude. The other end of the central tube terminates with tubular arms extending laterally away from the central tube, each with an arc shape. The tubular arms terminate with plant hangers supporting plant pots depending downwardly. A water conduit conducts water through the central tube and the tubular arms to sprinkler heads within the plant pots. A source of illumination is engaged with the tubular arms and an electrical conduit conducts electricity from an electrical source through the central tube and the tubular arms, to the illumination source.

A primary objective inherent in the above described apparatus and method of use is to provide advantages not taught by the prior art.

Another objective is to provide a self-watering plant stand.

A further objective is to provide a decorative plant stand visually free of water tubes.

A further objective is to provide a plant stand with a light source for illuminating hung plants.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus;

FIG. 2 is a perspective view of the apparatus as powered by an internal power source;

FIG. 3 is a perspective view of the apparatus as powered by an external power source.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

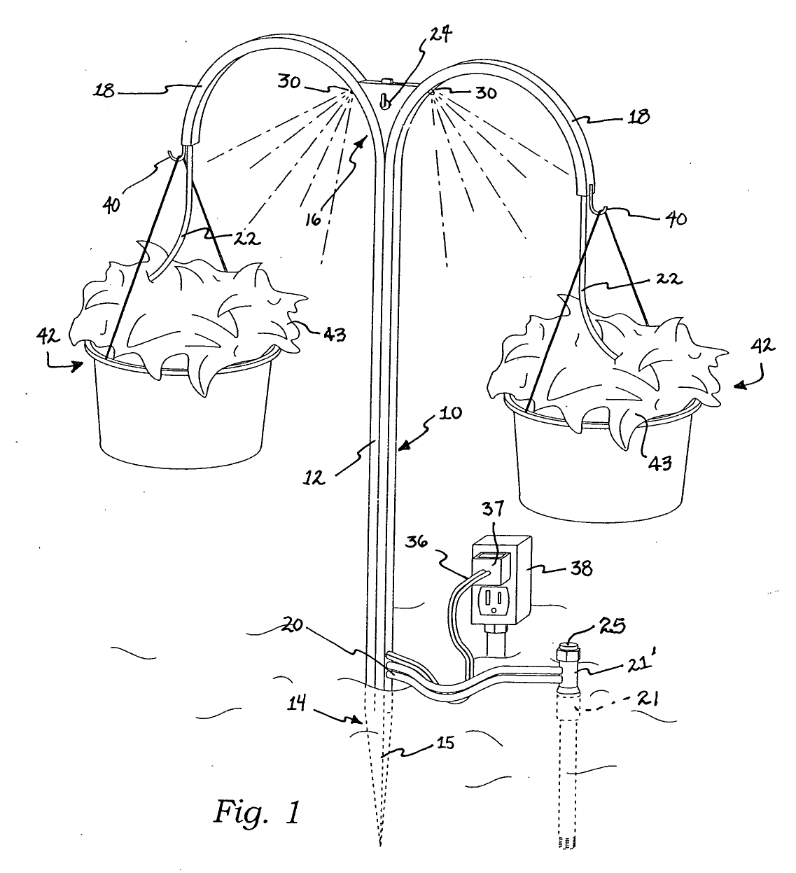

Described now in detail is a plant watering and illuminating apparatus 10 (FIGS. 1-3). A means for central supporting 12 is adapted at one end 14, the adaptation preferably being at least one rigid spike 15, for vertical positioning in relation to a ground surface, as shown in FIG. 1. The central supporting means 12 is preferably an extruded central tube constructed of a rigid material and having a hollow center. The means of central supporting 12 is adapted at an other end 16 for terminating with a means for lateral supporting 18, also preferably constructed as an extruded hollow tubular arm of rigid material, as shown in FIG. 1. The means for lateral supporting 18 is extended in an arc away from the central supporting means 12 and is terminated with a means for plant hanging 40; the means for plant hanging 40 being any well known plant hanger such as an extended hook. A means for plant potting 42, such as any well known ceramic, plastic or other similar material plant pot, is mounted on the plant hanging means 40 and extends downwardly to house a plant 43 within the plant potting means 42 as shown in FIG. 1.

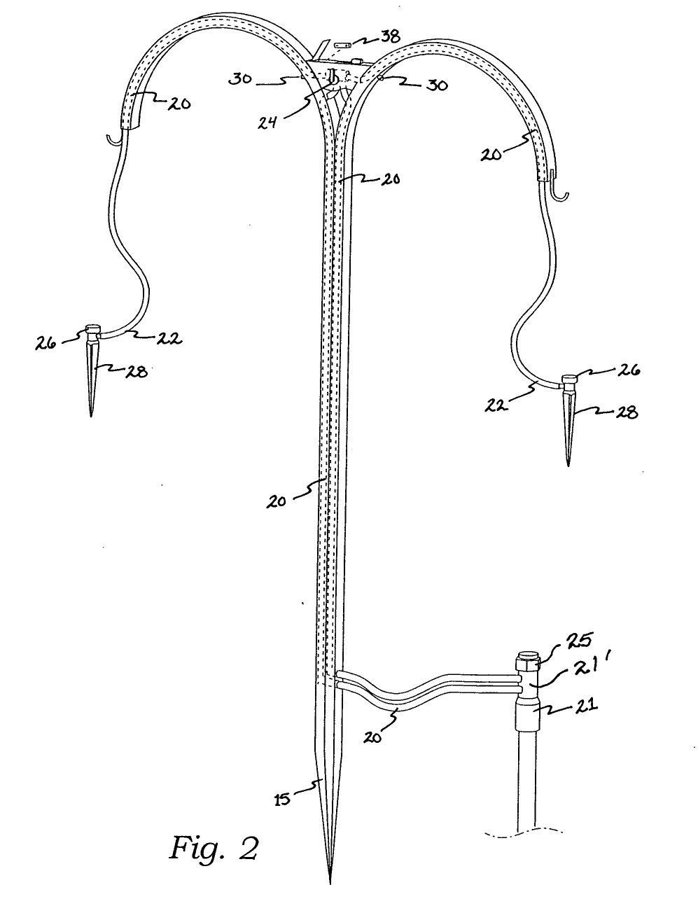

A means for conducting water 20 through the central supporting means 12 and the lateral supporting means 18 terminates at a distal end 22 within the means for plant potting 42 as shown in FIG. 2. Also shown in FIG. 2, the water conducting means 20 is preferably a flexible water conduit tube extending from a water source 21 and positioned inside the hollow space of the central 12 and lateral 18 supporting means so that water may flow from the water source 21 to the distal end 22 of the water conducting means 20. A means for valving 24, preferably a hand adjustable valve, is mounted within the central supporting means 12 and interconnected with the water conducting means 20 as shown in FIG. 2. The valving means 24 is adjustable for regulating the flow of water through the water conducting means 12 in a steady manner. As shown in FIG. 2, a means for sprinkling 26 is mounted at the distal end 22 of the water conducting means 20, preferably by a standard connecting nipple. The sprinkling means 26 is preferably a common sprinkler head engaged with a means for staking 28. Such a configuration allows the sprinkling means 26 to be inserted via the staking means 28 into a potted soil at a chosen elevation and the level of water flow from the sprinkling means 26 then can be adjusted by the valving means 24.

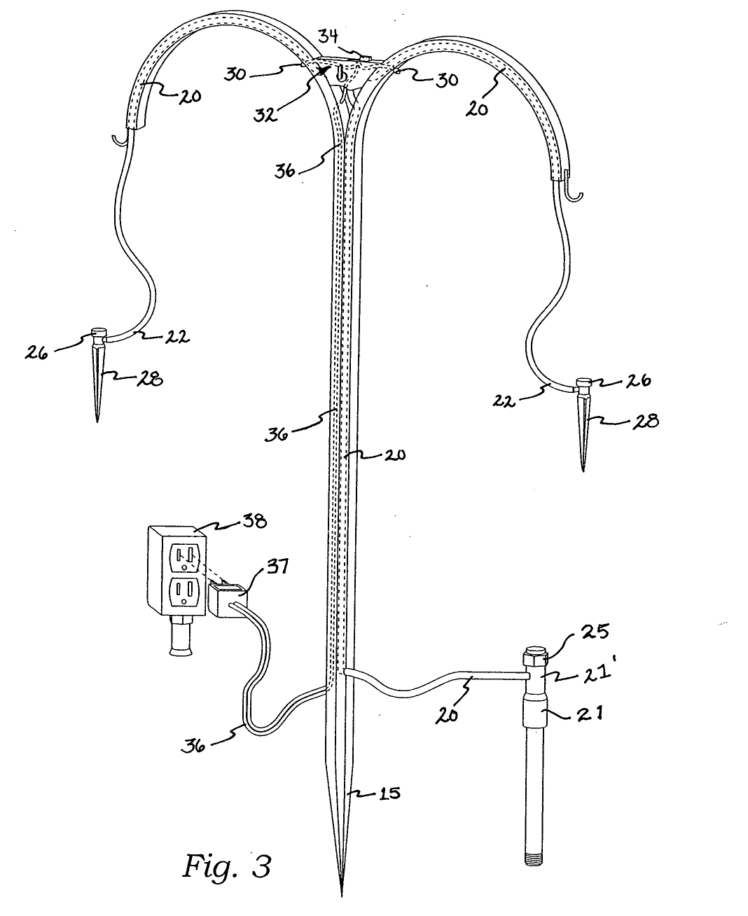

A means for illumination 30, such as an LED light or other source of illumination, engages the lateral supporting means 18 at a position enabling the illumination means to project light upon the potted plant 43 as shown in FIG. 1. A means for conducting electricity 36, preferably a standard electrical wire is conducted within the central 12 and lateral 18 supporting means, thereby joining the illumination means 30 with an external source of electrical power 38 as shown in FIG. 3. Preferably, the source of electrical power 38 is a standard house outlet at 120 VAC and is preferably modified to a 12-volt direct current by standard electrical methods such as the use of a transformer and a half-wave rectifier in a plug adapter 37 as shown in FIGS. 1 and 3. In another embodiment, the source of electrical power 38 is internal, preferably as a replaceable or rechargeable 12-volt battery as shown in FIG. 2. In this alternate embodiment, the means for conducting electricity 36 then joins the illumination means 30 and the internal source of electrical power 38. As shown in FIG. 3, a means for electrical switching 32, preferably a standard electrical switch, may include a means for dimming 34 and is mounted within the central supporting means 12. The dimming means 34 is adjustable for setting an illumination level.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A plant watering and illuminating apparatus comprising: a central tube having at one end an adaptor for supporting the central tube in a vertical attitude, the other end of the central tube terminating with at least one tubular arm extending laterally away from the central tube in an arc, the at least one tubular arm terminating with a plant hanger; a plant pot mounted on the plant hanger and extending downwardly therefrom; a water conduit conducted through the central tube and the at least one tubular arm, the water conduit terminating at a distal end thereof in the plant pot; a source of illumination engaged with the at least one tubular arm; an electrical conduit conducted through the central tube and the at least one tubular arm, joining the illumination source to a source of electrical power.

2. The apparatus of claim 1 further comprising a valve mounted within the central tube and interconnected with the water conduit, the valve adjustable for regulating the flow of water through the water conduit.

3. The apparatus of claim 1 further comprising a sprinkler head mounted at a terminal end of the water conduit.

4. The apparatus of claim 3 further comprising a stake engaged with the sprinkler head.

5. The apparatus of claim 1 further comprising an electrical switch mounted within the central tube, the electrical switch adjustable for setting an illumination level.

6. The apparatus of claim 5 wherein the electrical switch includes a dimmer adjustment.

7. The apparatus of claim 1 wherein the water conduit terminates proximally at a sprinkler riser adapter, the adapter engaged with a sprinkler riser, a sprinkler head terminating the adapter, the adapter having at least one nipple engaged with the water conduit.

8. A plant watering and illuminating apparatus comprising: a central tube having at one end an adaptor for supporting the central tube in a vertical attitude, the other end of the central tube terminating with plural tubular arms, each extending laterally away from the central tube in an arc, each of the tubular arms terminating with a plant hanger; a plant pot mounted on each of the plant hangers and extending downwardly therefrom; a water conduit conducted through the central tube and the tubular arms, the water conduit terminating at distal ends thereof in the plant pots; a source of illumination engaged with the tubular arms; an electrical conduit conducted through the central tube and the tubular arms, joining the illumination source to a source of electrical power.

9. The apparatus of claim 8 further comprising a valve mounted within the central tube and interconnected with the water conduit, the valve adjustable for regulating the flow of water through the water conduit.

10. The apparatus of claim 8 further comprising a sprinkler head mounted at each of the terminal ends of the water conduits.

11. The apparatus of claim 10 further comprising a stake engaged with of the sprinkler heads.

12. The apparatus of claim 8 further comprising an electrical switch mounted within the central tube, the electrical switch adjustable for setting an illumination level.

13. The apparatus of claim 12 wherein the electrical switch includes a dimmer adjustment.

14. The apparatus of claim 8 wherein the water conduit terminates proximally at a sprinkler riser adapter, the adapter engaged with a sprinkler riser, a sprinkler head terminating the adapter, the adapter having at least one nipple engaged with the water conduit.

15. A plant watering and illuminating apparatus comprising: a means for central supporting adapted at one end thereof for positioning the supporting means in a vertical attitude, the other end of the supporting means terminating with a means for lateral supporting extending in an arc away from the central supporting means, the lateral supporting means terminating with a means for plant hanging; a means for plant potting mounted on the plant hanging means and extending downwardly therefrom; a means for conducting water through the central supporting means and the lateral supporting means, the water conducting means terminating at a distal end thereof within the means for plant potting; means for illumination engaged with the lateral supporting means; a means for electricity conducting within the central and lateral supporting means, thereby joining the illumination means and a source of electrical power.

16. The apparatus of claim 15 further comprising a means for valving mounted within the central supporting means and interconnected with the water conducting means, the valving means adjustable for regulating the flow of water through the water conducting means.

17. The apparatus of claim 15 further comprising a means for sprinkling mounted at the distal end of the water conducting means.

18. The apparatus of claim 17 further comprising a means for staking engaged with the sprinkling means.

19. The apparatus of claim 15 further comprising a means for electrical switching mounted within the central supporting means, the electrical switching means adjustable for setting an illumination level.

20. The apparatus of claim 19 wherein the electrical switching means includes a means for dimming.
